(19) United States
(12) Patent Application Publication
(10) Pub. No.: US 2021/0404914 A1
(43) Pub. Date: Dec. 30, 2021

(54) TIME SERIES SENSOR DATA PROCESSING DEVICE AND TIME SERIES SENSOR DATA PROCESSING METHODS

(71) Applicant: RENESAS ELECTRONICS CORPORATION, Tokyo (JP)

(72) Inventor: Masayuki SHIMOBEPPU, Tokyo (JP)

(21) Appl. No.: 17/314,328

(22) Filed: May 7, 2021

(30) Foreign Application Priority Data
Jun. 26, 2020 (JP) 2020-110215

(51) Int. Cl. G01M 99/00; G06N 3/08; G06F 16/22

(52) U.S. Cl. CPC G01M 99/005; G06F 16/22; G06N 3/08

(57) ABSTRACT

A time series sensor data processing device is provided. The time series sensor data processing device includes: a frame generating unit configured to generate a plurality of frames from time series sensor data acquired from a sensor, each of the frames having a predetermined frame size, the sensor being provided in an apparatus; a time information adding unit configured to add a value indicating corresponding time information to each of the generated frames; and a determining unit configured to determine presence or absence of an abnormality of the apparatus by using a neural network, the neural network learning a combination of each of the plurality of frames and the value indicating the corresponding time information and a combination of a data pattern of each frame stored in advance and predetermined timing.

### CROSS-REFERENCE TO RELATED APPLICATIONS

The disclosure of Japanese Patent Application No. 2020-110215 filed on Jun. 26, 2020 including the specification, drawings and abstract is incorporated herein by reference in its entirety.

### BACKGROUND

The present disclosure relates to a time series sensor data processing device and a time series sensor data processing method. Many rotary members including motors and the like are mounted in home electronic appliances and business machines. When such an apparatus is operated, an operating noise is usually generated due to rotation of the rotary member. It is known to detect an abnormality of the rotary member in each of the home electronic appliances and the business machines by analyzing this operating noise by means of a predetermined method.

For example, Japanese Unexamined Patent Application Publication No. 2003-085157 discloses an abnormality determining system in which data are first read out from waveform data stored in a data memory as a processing target while shifting by ½ of a frame size in on a time axis, and a plurality of frames is generated. Further, the abnormality determining system includes a damping unit configured to set amplitudes at both ends of the data of each frame to zero; multiplies a window function to each generated frame so that a region of a stability detecting unit in the center of the frame data is configured to be flat; and then executes FFT processing. Moreover, the abnormality determining system gives feature amounts extracted on the basis of frequency spectrum information obtained by the FFT processing to a determining unit, and the determining unit executes fuzzy inference to determine presence or absence of an abnormality (a defective product).

Further, Non-Patent Document 1 describes Elman network, which is an early simple RNN (Recurrent Neural Network), as a neural network for dealing with time series information. The Elman network is a kind of neural network in which a calculation result of an intermediate layer of the neural network is temporarily stored in a sequential circuit (or a memory) called a context layer, and at the time of calculation of next data, information of an input layer and information of the stored context layer are used to obtain the calculation result of the intermediate layer. As a result, it is possible to learn a flow of time series data to be inputted, and this makes it possible to apply the learning to analysis of the inputted context.

There are disclosed techniques listed below.
[Patent Document 1] Japanese Unexamined Patent Application Publication No. 2003-085157
[Non-Patent Document 1] COGNITIVE SCIENCE volume 14, pages 179-211

### SUMMARY

In a technical field of detecting an abnormality of an apparatus, there is a request to want to determine that the apparatus is normal in a case where a specific data pattern occurs at certain timing; and to determine that the apparatus is abnormal in a case where the same data pattern occurs at another timing.

In the abnormality determining system described in Patent Document 1, when the obtained data pattern is a specific data pattern indicating an abnormality, the determining unit determines that the abnormality occurs in the apparatus. For this reason, for example, in a case where it is desired to determine that the apparatus is normal when a specific waveform pattern appears in a frame 1, and to determine that an abnormality occurs in the apparatus when the same waveform pattern appears in a frame 4, then this abnormality determining system cannot correctly determine a normality or an abnormality of the apparatus.

Further, in the Elman network described in Non-Patent Document 1, in a case where it is determined that the apparatus is normal when a specific waveform pattern appears in a frame m, a series of waveform patterns that appears before the frame m as a determination target ( . . . , a frame m-3, a frame m-2, and a frame m-1) are also learned as a normality. For this reason, for example, in a case where it is desired to determine that the apparatus is normal when a specific waveform pattern appears in the frame m, and to determine that an abnormality occurs in the apparatus when the same waveform pattern appears in a frame n, it is possible to correctly determine that the abnormality occurs in the frame n only when a series of waveform patterns that appears before the frame n ( . . . , a frame n-3, a frame n-2, and a frame n-1) is different from the series of waveform patterns that appears before the frame m.

However, it is desired to determine, in a case where a series of the same waveform patterns repeatedly appears periodically, for example, that it is normal for the series to be repeated up to j times, but to determine that it is abnormal for the series to be repeated j+1 times. In this case, when it is assumed that j is sufficiently large, the series of waveform patterns at the j times is equivalent to the series of waveform patterns before the j+1 times. Therefore, it is impossible to correctly determine the abnormality by the method described in Non-Patent Document 1.

Moreover, there is a problem that compared with feedforward type neural networks, the RNN is less likely converge learning due to a gradient vanishing problem, and requires a memory in a context layer. For this reason, there is also a problem that a large amount of memory resources is consumed.

The other object and new feature will become apparent from description of the present specification and the accompanying drawings.

The present invention has been made in view of the above problems, and it is an object of the present disclosure to provide a time series sensor data processing device and a time series sensor data processing method capable of switching between normal determination and abnormal determination even though the same data patterns are generated at different timings by adding information indicating a time to data acquired from a sensor, learning and determining them.

According to one embodiment, there is provided a time series sensor data processing device that includes: a frame generating unit configured to generate a plurality of frames from time series sensor data acquired from a sensor, each of the frames having a predetermined frame size, the sensor being provided in an apparatus; a time information adding unit configured to add a value indicating corresponding time information to each of the generated frames; and a determining unit configured to determine presence or absence of an abnormality of the apparatus by using a neural network, the neural network learning a combination of each of the plurality of frames and the value indicating the corresponding time information and a combination of a data pattern of each frame stored in advance and predetermined timing.

### BRIEF DESCRIPTION OF THE DRAWINGS

FIG. 1 is a configuration diagram illustrating one example of a time series sensor data processing device according to a first embodiment.

FIG. 2 is a configuration diagram illustrating one example using a semiconductor device as the time series sensor data processing device illustrated in FIG. 1.

FIG. 3 is a configuration diagram illustrating another example using a semiconductor device as the time series sensor data processing device illustrated in FIG. 1.

FIG. 4 is a flowchart illustrating a learning data collecting flow according to the first embodiment.

FIGS. 5A-5E are views illustrating images of processed data with respect to sensor inputs at Steps S101 to S107 in the flowchart illustrated in FIG. 4.

FIG. 6 is a flowchart illustrating a learning flow according to the first embodiment.

FIG. 7 is a flowchart illustrating an inference flow according to the first embodiment.

FIGS. 8A-8E are explanatory drawings for explaining effects by addition of time information.

FIG. 9 is a configuration diagram illustrating one example using a semiconductor device according to a second embodiment.

FIG. 10 is a flowchart illustrating a learning data collecting flow according to the second embodiment.

FIG. 11 is a flowchart illustrating a learning flow according to the second embodiment.

FIG. 12 is an explanatory drawing illustrating a relationship between a time information value and the number of all frames.

FIGS. 13A-13E are views illustrating images when an absolute value of a difference between consecutive frames according to a third embodiment is calculated.

FIG. 14 is a configuration diagram illustrating one example using a semiconductor device according to a fourth embodiment.

### DETAILED DESCRIPTION

In embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Further, in the embodiments described below, in a case of referring to the number of elements (including number of pieces, values, amount, range, and the like), the number of the elements is not limited to a specific number unless otherwise stated or except the case where the number is apparently limited to a specific number in principle, and the number larger or smaller than the specified number may also be applicable. Moreover, in the embodiments described below, it goes without saying that the components (including element steps and the like) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Hereinafter, the embodiments will be described in detail with reference to the drawings. Note that in all of the drawings for explaining the embodiments, the same reference numeral is assigned to members having the same function, and repeated explanation thereof will be omitted. Further, in the following embodiments, in principle, explanation of the same or similar will not be repeated unless otherwise necessary.

### First Embodiment

<Configuration of Time Series Sensor Data Processing Device>

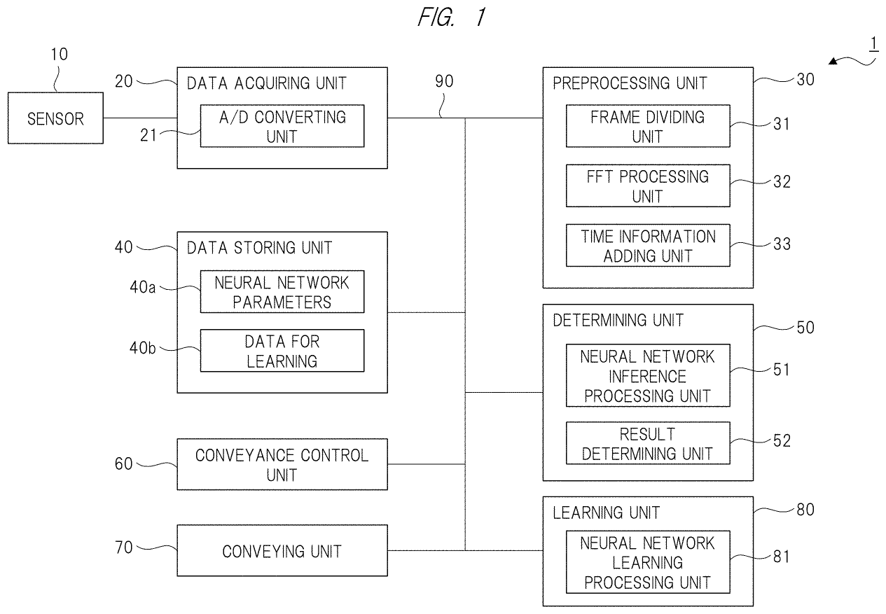

First, one example of a configuration of a time series sensor data processing device 1 will be described. FIG. 1 is a configuration diagram illustrating one example of the time series sensor data processing device 1 according to the first embodiment. In the present embodiment, a case where the time series sensor data processing device 1 constitutes apart of a so-called multifunction machine will be described as one example. However, the time series sensor data processing device 1 according to the present embodiment maybe applied to other home electronic appliances, other business machines, or the like.

As illustrated in FIG. 1, the time series sensor data processing device 1 according to the present embodiment includes a sensor 10, a data acquiring unit 20, a preprocessing unit 30, a data storing unit 40, a determining unit 50, a conveyance control unit 60, a conveying unit 70, and a learning unit 80. Each of the units 20 to 80 other than the sensor 10 is connected to a bus 90, and is allowed to exchange data with each other via the bus 90.

The sensor 10 is provided at a predetermined position in the multifunction machine, for example, in the vicinity of a position at which an operating noise is generated due to movement of a paper in the multifunction machine. In the present embodiment, the sensor 10 is a sound sensor for detecting the operating noise of the multifunction machine, and is configured by a microphone, for example. The sensor 10 is configured so as to detect the operating noise when the multifunction machine performs a printing operation, for example. The sensor 10 then outputs the detected time series sound data (hereinafter, referred to also as “time series sensor data”) to the data acquiring unit 20.

The data acquiring unit 20 includes an A/D converting unit 21. The data acquiring unit 20 acquires time series sensor data with analog values from the sensor 10, and the A/D converting unit 21 A/D-converts analog time series sensor data into digital time series sensor data. Then, the data acquiring unit 20 outputs the digital value time series sensor data to the bus 90.

The preprocessing unit 30 is configured so as to receive the time series sensor data outputted from the data acquiring unit 20, and execute preprocessing for determination of the determining unit 50 (will be described later). The preprocessing unit 30 includes a frame dividing unit 31, an FFT processing unit 32, and a time information adding unit 33.

The frame dividing unit 31 is configured so as to divide the time series sensor data into a plurality of frames and generate the plurality of frames so that each of the frames has a predetermined frame size. Namely, the frame dividing unit 31 serves as a frame generating unit. The frame dividing unit 31 in turn outputs the divided plurality of frames to the FFT processing unit 32.

The FFT processing unit 32 is configured so as to execute FFT processing for frame data of each frame outputted from the frame dividing unit 31. The FFT processing unit 32 outputs the frame data subjected to the FFT processing to the time information adding unit 33 as a frequency spectrum.

The time information adding unit 33 is configured so as to add a value indicating time information corresponding to the frame to the frequency spectrum of each frame outputted from the FFT processing unit 32. The preprocessing unit 30 then outputs the plurality of frame data, to which the value indicating the time information is added, to the bus 90.

The data storing unit 40 is configured so as to store neural network parameters 40a and data for learning 40b . The neural network parameters 40a are used by a neural network inference processing unit 51 in the determining unit 50 (will be described later).

Further, the data for learning 40b are used by a neural network learning processing unit 81 in the learning unit 80 (will be described later).

The determining unit 50 is configured so as to determine presence or absence of an abnormality of the multifunction machine by using a neural network that is learned by the plurality of frame data, to each of which the value indicating the time information outputted from the preprocessing unit 30 is added, and the neural network parameters 40a stored in the data storing unit 40. In the present embodiment, the determining unit 50 includes a neural network inference processing unit 51 and a result determining unit 52.

The neural network inference processing unit 51 is configured so as to execute neural network inference processing for the plurality of frame data, to each of which the value indicating the time information is added, by using the neural network parameters 40a stored in the data storing unit 40, and outputs a processing result thereof to the result determining unit 52.

The result determining unit 52 is configured so as to determine presence or absence of an abnormality of the multifunction machine on the basis of the processing result of the neural network inference processing unit 51. Note that the result determining unit 52 may output a determination result thereof to the data storing unit 40 via the bus 90, and the data storing unit 40 may store the determination result therein.

The conveyance control unit 60 is configured so as to control an operation of the conveying unit 70. For example, in response to an operation to the multifunction machine by a user (for example, a printing operation, a copy operation, and the like), the conveyance control unit 60 controls the conveying unit 70 to convey a paper or the like, which is a conveyance target. The conveying unit 70 is configured so as to convey the paper or the like to a predetermined position in accordance with the control of the conveyance control unit 60.

The learning unit 80 is configured so as to receive the time series sensor data outputted from the data acquiring unit 20 or the time series sensor data temporarily stored in the data storing unit 40, and execute a predetermined learning process. In the present embodiment, the learning unit 80 includes a neural network learning processing unit 81.

The neural network learning processing unit 81 is configured so as to execute a neural network learning process in response to a learning instruction from the user by using the data for learning 40b stored in the data storing unit 40. Then, the neural network parameters 40a acquired by the learning process by means of the neural network learning processing unit 81 are stored in the data storing unit 40.

<One Configuration Example of Time Series Sensor Data Processing Device>

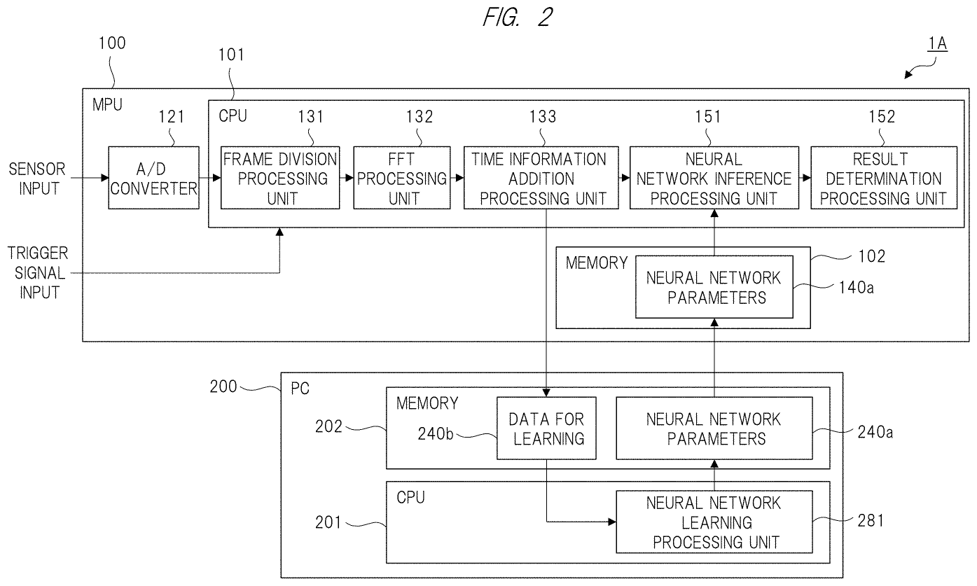

FIG. 2 is a configuration diagram illustrating one example using a semiconductor device as the time series sensor data processing device 1 illustrated in FIG. 1. As illustrated in FIG. 2, a time series sensor data processing device 1A includes a microprocessor (MPU) 100 as a semiconductor device and a personal computer (PC) 200.

The MPU 100 as the semiconductor device is formed on a semiconductor substrate (or a semiconductor chip) made of single crystal silicon by using a known CMOS manufacturing process, for example.

As illustrated in FIG. 2, the MPU 100 includes an A/D converter 121, a CPU 101, and a memory 102. The MPU 100 operates in accordance with a sensor input and/or a trigger signal input from the outside. Time series sensor data with analog values are continuously inputted to the A/D converter 121 from the sensor 10 illustrated in FIG. 1. The A/D converter 121 is configured so as to sequentially sample the inputted analog time series sensor data, and A/D-convert them into digital time series sensor data to output the digital time series sensor data.

For example, in a case where the time series sensor data processing device 1A is mounted in a printer and it is desired to determine a normality or an abnormality of the printer from an operating noise when printing once, time series sound data are inputted from the microphone as the sensor input, and a signal that becomes active at the time of printing (for example, a control signal or the like in the printer) is inputted into the CPU 101 as the trigger signal input.

The CPU 101 includes a frame division processing unit 131, an FFT processing unit 132, a time information addition processing unit 133, a neural network inference processing unit 151, and a result determination processing unit 152. These respectively correspond to the frame dividing unit 31, the FFT processing unit 32, the time information adding unit 33, the neural network inference processing unit 51, and the result determining unit 52, which are illustrated in FIG. 1. The CPU 101 repeatedly operates the frame division processing unit 131, the FFT processing unit 132, and the time information addition processing unit 133 for continuously inputted digital data as software processing while a trigger signal inputted from the outside is active.

The frame division processing unit 131 is configured so as to execute frame division processing in which the time series sensor data are divided into a plurality of frames and the plurality of frames is generated so that each of the frames has a predetermined frame size. The frame division processing unit 131 then outputs the generated plurality of frame data to the FFT processing unit 132.

The FFT processing unit 132 is configured so as to execute FFT processing for the frame data of each frame outputted from the frame division processing unit 131. The FFT processing unit 132 then outputs data after the FFT processing to the time information addition processing unit 133.

The time information addition processing unit 133 is configured so as to execute time information addition processing in which a value indicating time information corresponding to each frame is added to a frequency spectrum of the corresponding frame outputted from the FFT processing unit 132. The time information addition processing unit 133 then outputs the plurality of frame data, to which the generated values each indicating the time information are respectively added by repeated execution of these processes, to the neural network inference processing unit 151 and the PC 200. This time information addition processing is a process of adding the time information to the frequency spectrum outputted from the FFT processing unit 132, which is a characteristic process of the present embodiment.

Neural network parameters 140a are stored in the memory 102. The neural network parameters 140a are utilized for neural network inference processing by the neural network inference processing unit 151.

The neural network inference processing unit 151 is configured so as to execute the neural network inference processing by using the neural network parameters 140a stored in the memory 102. The neural network inference processing unit 151 then outputs a result of the neural network inference processing to the result determination processing unit 152.

The result determination processing unit 152 is configured so as to execute result determination processing on the basis of the result of the neural network inference processing by the neural network inference processing unit 151. Note that a determination result of the result determination processing may be stored in the memory 102, for example, and may be displayed on a display (not illustrated in the drawings) or the like. Alternatively, the MPU 100 may transmit the determination result of the result determination processing to the PC 200, and the PC 200 may display the received determination result on the display or the like.

The PC 200 includes a CPU 201 and a memory 202. The PC 200 is configured so as to execute a learning process by a neural network by using data after the time information transmitted from the time information addition processing unit 133 of the MPU 100 is added.

Neural network parameters 240a and data for learning 240b are stored in the memory 202. Further, the memory 202 is configured so as to temporarily store the data after the time information transmitted from the time information addition processing unit 133 of the MPU 100 is added as the data for learning 240b.

The CPU 201 includes a neural network learning processing unit 281. The neural network learning processing unit 281 is configured so as to execute a neural network learning process when the data for learning 240b stored in the memory 202 are inputted in response to a learning instruction from a user, for example. The neural network parameters 240a after the neural network learning process by the neural network learning processing unit 281 are temporarily stored in the memory 202 of the PC 200, and are then transferred to the memory 102 of the MPU 100 to be used for neural network inference processing by the neural network inference processing unit 151.

Note that in the present embodiment, the case where the FFT processing unit 132 and the neural network inference processing unit 151 in the CPU 101 of the MPU 100 execute various kinds of processes as the software processing has been described. However, the present invention is not limited to this. For example, as hardware processing, these processes may be executed by using data processing apparatuses such as a DSP (Digital Signal Processor) or a GPGPU (General Purpose computing on Graphics Processing Units).

Further, in the present embodiment, the case where the FFT processing by the FFT processing unit 132 is executed after the frame division processing by the frame division processing unit 131 has been described. However, the time series sensor data may be used as they are in the subsequent processes without executing the FFT processing.

<Another Configuration Example of Time Series Sensor Data Processing Device>

Next, another example of the configuration of the time series sensor data processing device 1 will be described.

The case where in the time series sensor data processing device 1A illustrated in FIG. 2, the result determination processing unit 152 of the MPU 100 determines the result acquired by the neural network inference processing by means of the neural network inference processing unit 151 and the neural network learning processing unit 281 of the PC 200 executes the neural network learning process has been described. However, the MPU 100 may be configured so as to execute both of the processes.

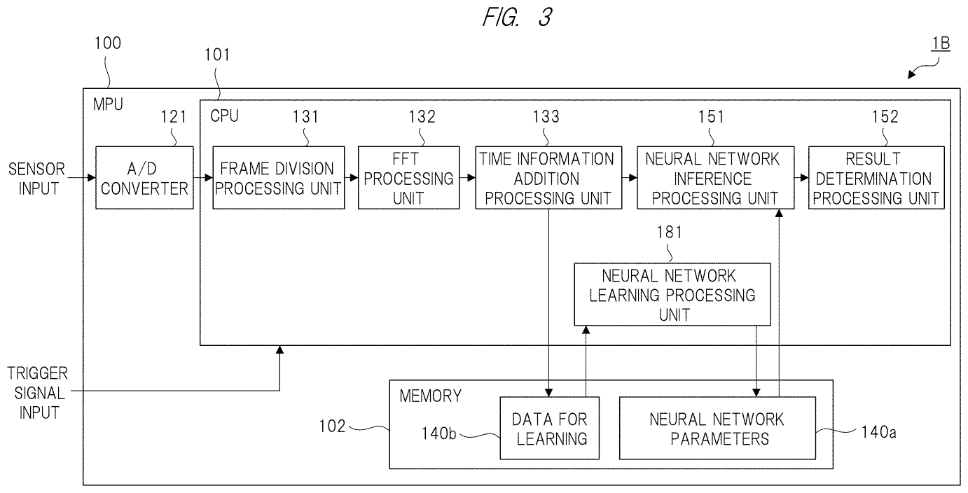

FIG. 3 is a configuration diagram illustrating another example using a semiconductor device as the time series sensor data processing device 1 illustrated in FIG. 1. As illustrated in FIG. 3, a time series sensor data processing device 1B does not include a PC 200, but includes only an MPU 100. The time series sensor data processing device 1B illustrated in FIG. 3 executes a learning process by an MPU 100.

The MPU 100 as the semiconductor device includes an A/D converter 121, a CPU 101, and a memory 102. The MPU 100 operates in accordance with a sensor input and/or a trigger signal input from the outside.

Unlike the MPU 100 illustrated in FIG. 2, the CPU 101 further includes a neural network learning processing unit 181. Further, data for learning 140b are also stored in the memory 102 in addition to neural network parameters 140a.

A time information addition processing unit 133 is configured so as to output a plurality of frame data, to which values indicating time information generated by repeated execution of frame division processing, FFT processing, and time information addition processing are respectively added, to a neural network inference processing unit 151, and temporarily store them in the memory 102.

The neural network learning processing unit 181 is configured so as to execute a neural network learning process using the data for learning 140b stored in the memory 102, and store the neural network parameters 140a acquired as a result in the memory 102.

The neural network inference processing unit 151 is configured so as to execute neural network inference processing by using the plurality of frame data, to which the values indicating the time information outputted from the time information addition processing unit 133 are added, and the neural network parameters 140a stored in the memory 102, and to output a result of the neural network inference processing to the result determination processing unit 152.

<Operation of Time Series Sensor Data Processing Device>

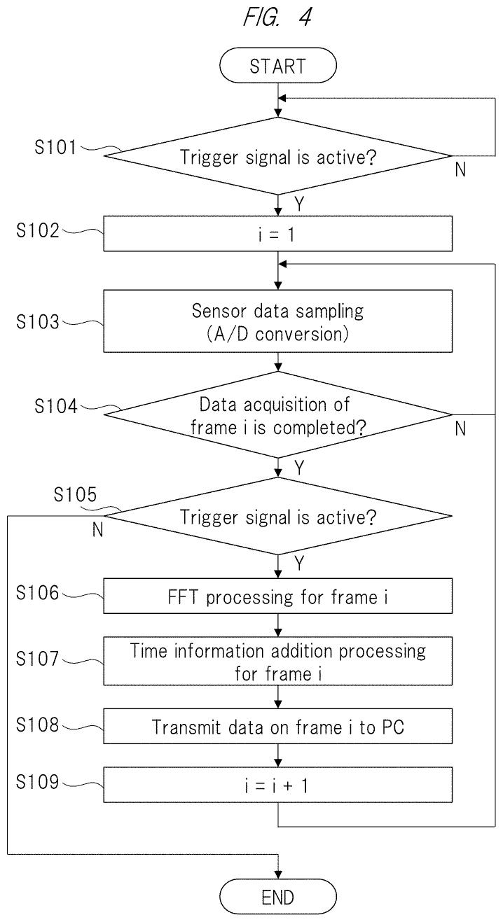

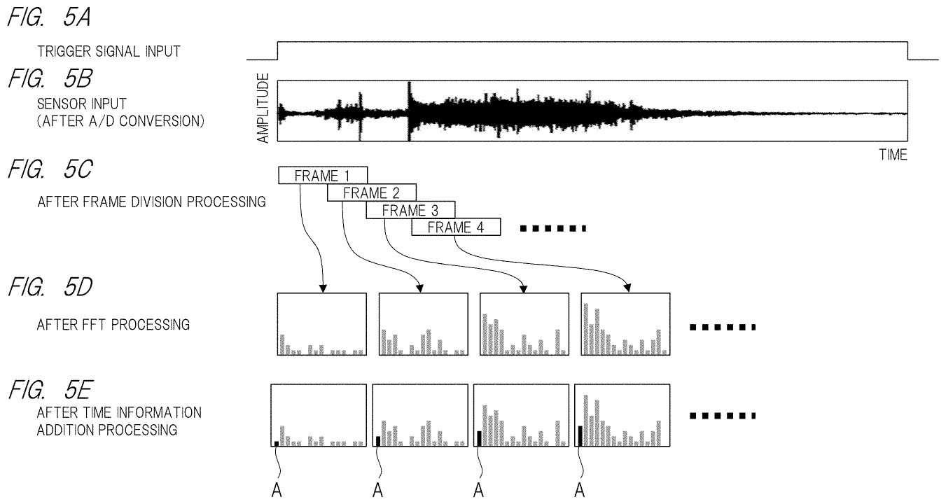

Next, an operation of the time series sensor data processing device 1 will be described. FIG. 4 is a flowchart illustrating a learning data collecting flow according to the first embodiment. FIGS. 5A-5E are views illustrating images of processed data with respect to the sensor inputs at Steps S101 to S107 in the flowchart illustrated in FIG. 4. First, the learning data collecting flow according to the present embodiment will be described with reference to FIG. 2 and FIG. 4.

The MPU 100 first monitors a state of a trigger signal input to the CPU 101. Namely, the MPU 100 determines whether the trigger input signal to the CPU 101 becomes active or not (Step S101). Then, the MPU 100 waits at Step S101 until the trigger input signal becomes active. Note that in the present embodiment, as illustrated in FIG. 5A, once the trigger signal input becomes active, the trigger signal input maintains an active state for a certain time.

In a case where it is determined that the trigger input signal becomes active (“Y” at Step S101), the MPU 100 initializes a frame number “i” to “1” (Step S102). Then, the MPU 100 executes sampling of sensor data in time series, and the A/D converter 121 A/D-converts the sensor data. The MPU 100 acquires one piece of data after the A/D conversion (Step S103). Here, FIG. 5B illustrates the sensor input after the A/D conversion.

Subsequently, the MPU 100 determines whether data acquisition of the frame number “i” is completed or not (Step S104). Specifically, the MPU 100 determines whether the number of data pieces in the frame number “i” (here, a “frame 1”) reaches a default value or not . The MPU 100 repeats the sampling of the sensor data at Step S103 until the number of data pieces in the frame 1 reaches the default value. As illustrated in FIG. 5C, the data of the frame 1, which is a first frame, are acquired by the processing up to this point.

In a case where it is determined that the number of data pieces in the frame 1 reaches the default value (“Y” at Step S104), the MPU 100 determines whether the trigger signal input is active or not again (Step S105). In a case where it is determined that the trigger input signal is active (“Y” at Step S105), the processing flow proceeds to Step S106. On the other hand, in a case where it is determined that the trigger input signal is no longer active (“N” at Step S105), the MPU 100 terminates this learning data collecting flow.

In a case where it is determined that the trigger input signal is active (“Y” at Step S105), the MPU 100 causes the FFT processing unit 132 to execute FFT processing for the data of the frame 1 (Step S106) to acquire a frequency spectrum after the FFT processing as illustrated in FIG. 5D.

The MPU 100 then adds a value indicating time information to the frequency spectrum of the frame 1 by the time information addition processing unit 133 (Step S107). Specifically, the time information addition processing unit 133 adds time information as illustrated by a mark A in FIG. 5E to the frequency spectrum of the frame 1. Note that a value of the time information A is a value obtained by multiplying a fixed value α by the frame number “i”. Note that the fixed value α may be any fixed value so long as a difference of volume of the time information A can be recognized in each frequency spectrum.

Subsequently, the MPU 100 transmits, to the PC 200, the data after the time information A is added to the frequency spectrum of the frame 1 (Step S108). Note that it is not illustrated in the flowchart, but the PC 200 stores data that are received at this timing as the data for learning 240b in the memory 202.

The MPU 100 then increments the frame number “i” to “2” (Step S109), and repeatedly executes the processes at Steps S103 to S109. As a result, as illustrated in FIG. 5C, data on frames 2 to 4, . . . , which are second to fourth, and . . . frames, are acquired in turn. Further, as illustrated in FIG. 5E, in each frequency spectrum, the volume of the time information A increases in proportion to the fixed value α.

When the learning data collecting flow is terminated in this manner, as illustrated in FIG. 5E, the frequency spectra of the plurality of frames to which the corresponding time information A is added can be acquired. In addition, the neural network inference processing unit 151 and the result determination processing unit 152 use the neural network learned by these frequency spectra of the plurality of frames and the neural network parameters 140a of the memory 102, whereby it is possible to determine presence or absence of an abnormality of the multifunction machine. Note that each of the neural network inference processing unit 151 and the result determination processing unit 152 corresponds to the determining unit illustrated in FIG. 1.

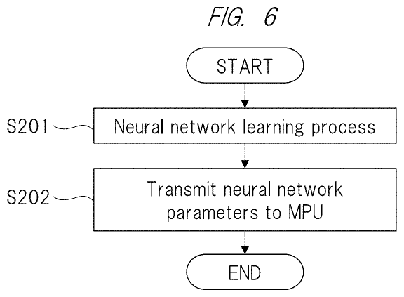

Next, a learning flow according to the present embodiment will be described with reference to FIG. 2 and FIG. 6. FIG. 6 is a flowchart illustrating the learning flow according to the first embodiment. The learning flow according to the present embodiment is started in a state where the learning data collecting flow illustrated in FIG. 4 is repeatedly executed several times by the MPU 100, and the data for learning 240b are thereby stored in the memory 202 of the PC 200.

The PC 200 first receives, from the MPU 100, data after the time information A is added to the frequency spectrum of the frame number “i”, and stores them in the memory 202. Then, the neural network learning processing unit 281 executes a neural network learning process by using the data for learning 240b stored in the memory 202 (Step S201). The PC 200 stores the neural network parameters 240a acquired by the neural network learning process in the memory 202.

Subsequently, the PC 200 transmits the neural network parameters 240a stored in the memory 202 to the MPU 100 (Step S202), and terminates this learning process. The MPU 100 that receives the neural network parameters 240a stores the neural network parameters 240a in the memory 102.

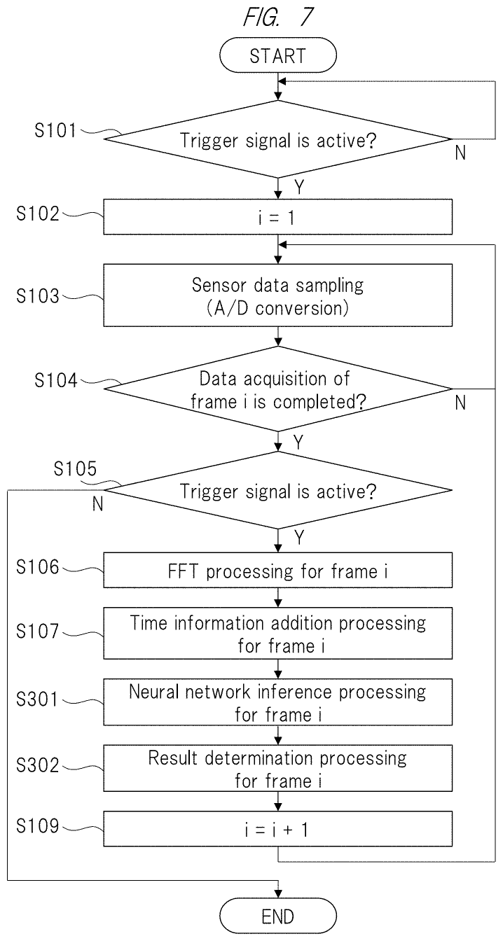

Next, an inference flow according to the present embodiment will be described with reference to FIG. 2 and FIG. 7. FIG. 7 is a flowchart illustrating the inference flow according to the first embodiment. Note that the same step number is assigned to the similar steps of the learning data collecting flow illustrated in FIG. 4, and explanation thereof will be omitted.

When the time information addition processing unit 133 adds the value indicating the time information to the frequency spectrum of the frame 1 (Step S107), the MPU 100 executes neural network inference processing for the frame number “i” by using the data after the time information of the frame number “i” acquired by the time information addition processing at Step S107 is added and the neural network parameters 140a stored in the memory 102 of the MPU 100 (Step S301).

Subsequently, the MPU 100 executes result determination processing for the frame number “i” by using a result (or an output) of the neural network inference processing (Step S302). In the result determination processing, the MPU 100 determines presence or absence of an abnormality of the multifunction machine by using the result of the neural network inference processing. For example, in a case where the determination of a normality or an abnormality of the multifunction machine is to be executed by using an autoencoder as the neural network, the MPU 100 determines whether a difference between input data and output data of the autoencoder exceeds a threshold value set in advance or not. Then, in a case where it is determined that the difference does not exceed the threshold value, the MPU 100 determines that the multifunction machine is normal. On the other hand, in a case where it is determined that the difference exceeds the threshold value, the MPU 100 determines that an abnormality occurs in the multifunction machine.

Then, the MPU 100 increments the frame number “i” (Step S109), and repeatedly executes the processes at Steps 5103 to 5107, 5301, S302, and S109.

<Features and Effects of First Embodiment>

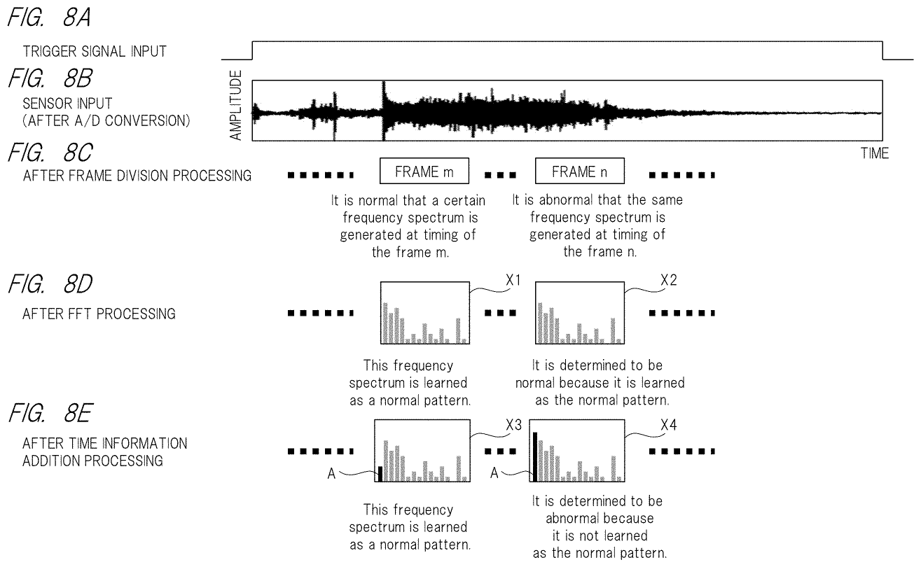

Next, main features and main effects of the time series sensor data processing device 1 according to the first embodiment will be described. FIGS. 8A-8E are explanatory drawings for explaining effects by addition of time information.

First, a feature of the time series sensor data processing devices 1A and 1B according to the present embodiment is the process of adding the value of the time information by the software processing of the MPU 100 in a case where the processing to add the value of the time information to the data of each frame after dividing the time series sensor data into the plurality of frames and executing the FFT processing for each frame (see the time information addition processing unit 133 illustrated in FIG. 2 and FIG. 3, and Step S107 illustrated in FIG. 4 and FIG. 7) is executed. As described above, the image of the data after the time information is added indicates the time information A illustrated in FIG. 5E.

In the example illustrated in FIGS. 8A-8E, as one example, it is thought a case where it is desired to determine that a multifunction machine is normal in a case where a certain frequency spectrum is generated at timing of a frame m, but to determine that an abnormality occurs in the multifunction machine in a case where the same frequency spectrum is generated at timing of a frame n.

Here, unlike the present embodiment, in a case where addition of the time information to the frequency spectrum is not executed, as illustrated in FIG. 8D, a frequency spectrum X1 after FFT processing for the frame m is learned as a normal pattern. For that reason, in a case where a frequency spectrum X2 after FFT processing for the frame n has the same pattern as the frequency spectrum X1 in neural network inference processing, the pattern of the frequency spectrum X1 is learned as normal pattern. Therefore, it is also determined that the pattern of the frequency spectrum X2 is normal .

Compared with such a conventional method, according to the present embodiment, in a case where the time information A is added to the frequency spectrum, as illustrated in FIG. 8E, a frequency spectrum X3 after the time information A is added to the frame m is learned as a normal pattern. For that reason, in the neural network inference processing, a shape of a frequency spectrum X4 after the time information is added to the frame n becomes a different pattern from the frequency spectrum X3 due to the addition of the time information A. Therefore, since the pattern of the frequency spectrum X4 is not learned as a normal pattern, it is determined that the pattern of the frequency spectrum X4 is regarded as occurrence of an abnormality.

By adding the time information A in this manner, it is possible to determine that the multifunction machine is normal in a case where the specific waveform pattern is generated at certain timing; and it is possible to determine that an abnormality occurs in the multifunction machine in a case where the same waveform pattern is generated at the other timing. As a result, in the abnormality determination based on the operating noise or the like, determination in consideration of generation timing of the operating noise becomes possible.

### Second Embodiment

Next, a second embodiment will be described. Note that the same reference numeral is assigned to each unit that has the similar function to that according to the first embodiment, and in principle, explanation thereof will be omitted.

<Configuration of Time Series Sensor Data Processing Device>

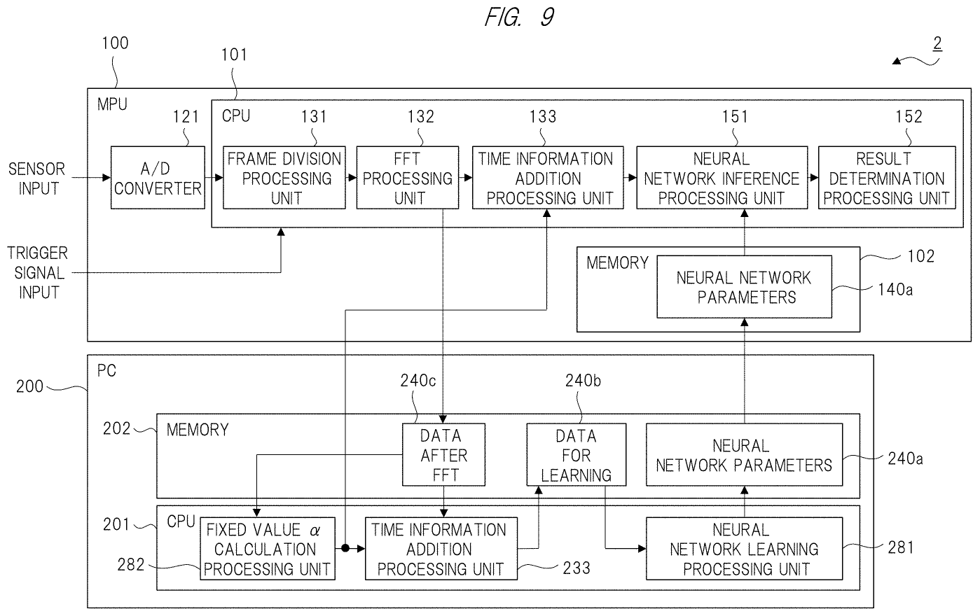

FIG. 9 is a configuration diagram illustrating one example using a semiconductor device according to the second embodiment. As illustrated in FIG. 9, a time series sensor data processing device 2 according to the present embodiment is different from the time series sensor data processing device 1A according to the first embodiment (see FIG. 2) in that a fixed value α is calculated. Namely, in the first embodiment, the case where the value obtained by multiplying the fixed value α by the frame number “i” is used for the time information A has been described. However, there is a problem that if this fixed value α is too small with respect to the value of the frequency spectrum, the degree of influence of the time information A becomes small, whereby it becomes difficult to obtain the effect of adding the time information A (that is, it becomes difficult to determine that it is abnormal). On the other hand, there is also a problem that if this fixed value α is too large with respect to the value of the frequency spectrum, the value of each frequency spectrum becomes relatively small, whereby it is thought that determination accuracy may be lowered.

In the present embodiment, in order to solve the problems, the volume of the time information A to be added is adjusted relative to a size of the corresponding frequency spectrum. Specifically, the value of the time information A to be added is determined by the following formulas.

(value of time information A)=(frame number “i”)×(fixed value α) (Formula 1)

(fixed value α)=(average value of frequency spectra of all frames)/((number of all frames)/2)×β (Formula 2)

Here, a value “β” is a parameter for controlling the degree of influence of the time information A. Note that an average value of frequency spectra of all frames is used as a parameter indicating the size of the frequency spectrum in Formula 2, but the maximum value or a variance value of the frequency spectra of all frames may be used.

As illustrated in FIG. 9, the time series sensor data processing device 2 includes a microprocessor (MPU) 100 and a personal computer (PC) 200. The MPU 100 has the similar configuration to that according to the first embodiment. However, in order to avoid repeated explanation, detailed explanation thereof will be omitted herein.

The PC 200 includes a CPU 201 and a memory 202. Further, the CPU 201 includes a time information addition processing unit 233, a neural network learning processing unit 281, a fixed value a calculation processing unit 282. Data after FFT 240c are stored in the memory 202 in addition to neural network parameters 240a and data for learning 240b similar to those according to the first embodiment.

In the present embodiment, the PC 200 is configured so as to execute a calculating process fora fixed value α by using frequency spectra transmitted from an FFT processing unit 132 of the MPU 100. Specifically, the PC 200 uses an average value of the frequency spectra of all frames and the number of all frames when the fixed value α is calculated. For that reason, the MPU 100 transmits, to the PC 200, data (frequency spectrum) after FFT processing is executed by the FFT processing unit 132. The PC 200 that receives the frequency spectrum temporarily stores the data in the memory 202 as the data after FFT 240c, and used the data for calculating the fixed value α.

The fixed value α calculation processing unit 282 is configured so as to calculate the average values of the frequency spectra of all frames on the basis of the data after FFT 240c temporarily stored in the memory 202, and calculate the fixed value α by using Formula 2 described above. The fixed value α calculation processing unit 282 transmits the calculated fixed value α to the MPU 100, and outputs the calculated fixed value α to the time information addition processing unit 233 in the CPU 201.

The time information addition processing unit 233 is configured so as to generate the data for learning 240b on the basis of the data after FFT 240c and the fixed value α. On the other hand, in the MPU 100, the fixed value α thus received is inputted to a time information addition processing unit 133 in order to add the time information A thereto. Note that in the example illustrated in FIG. 9, the case where the fixed value α thus calculated is directly inputted to the time information addition processing unit 133 is described, but this fixed value α may temporarily be stored in the memory 102.

The time information addition processing unit 233 is configured to calculate the time information A by using the fixed value acalculated by the fixed value α calculation processing unit 282, and add the time information A to the data after FFT 240c. The data after FFT 240c to which the time information A is added is stored in the memory 202 as the data for learning 240b.

The other units illustrated in FIG. 9 are substantially similar to the components illustrated in FIG. 2 according to the first embodiment. For that reason, detailed explanation thereof will be omitted herein.

<Operation of Time Series Sensor Data Processing Device>

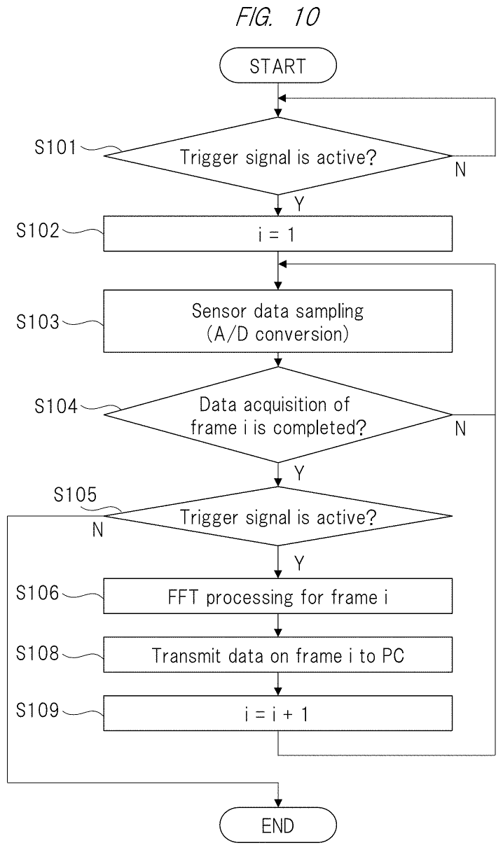

Next, an operation of the time series sensor data processing device 2 will be described. FIG. 10 is a flowchart illustrating a learning data collecting flow according to the second embodiment. First, the learning data collecting flow according to the present embodiment will be described with reference to FIG. 9 and FIG. 10. Note that in the learning data collecting flow according to the first embodiment (see FIG. 4), after the time information A is added to the frequency spectrum of the frame number “i” (see Step S107), data of the frame number “i” are transmitted to the PC 200 (see Step S108). However, the present embodiment is different from the first embodiment in that time information addition processing is not executed and data after FFT processing are transmitted to the PC 200.

Note that since processes at the other respective steps are similar to the steps according to the first embodiment (see FIG. 4), in order to avoid repeated explanation, detailed explanation thereof will be omitted herein.

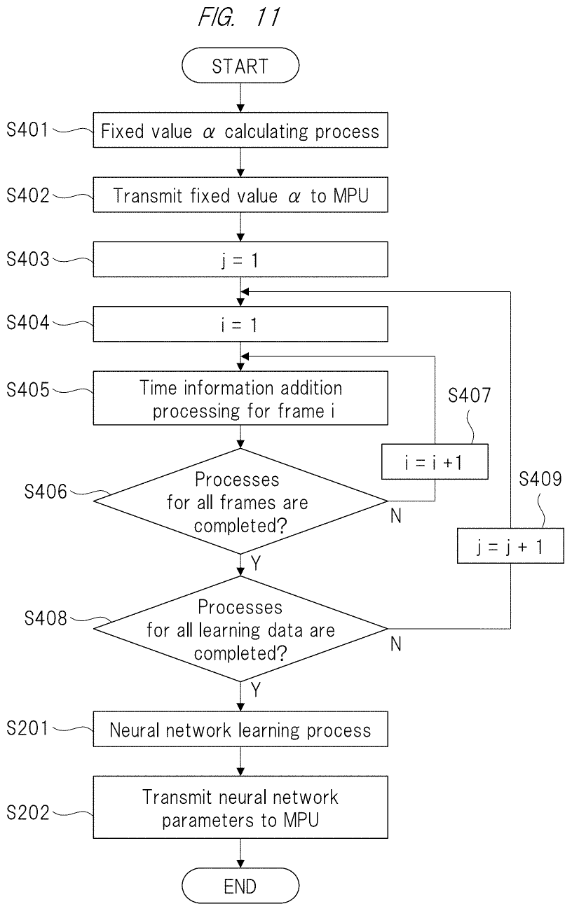

Next, a learning flow according to the present embodiment will be described with reference to FIG. 9 and FIG. 11. FIG. 11 is a flowchart illustrating the learning flow according to the second embodiment. Similar to the first embodiment, the learning flow according to the present embodiment is started in a state where the learning data collecting flow illustrated in FIG. 10 is repeatedly executed several times (here, j times) by the MPU 100, and the data for learning 240b are stored in the memory 202 of the PC 200.

The PC 200 first receives data after FFT processing from the MPU 100, and stores the received data in the memory 202 as the data after FFT 240c. Then, the fixed value α calculation processing unit 282 of the PC 200 calculates an average value of frequency spectra of all frames of the data for learning, which are collected for the first time, by using the data after FFT 240c stored in the memory 202, and calculates the fixed value α on the basis of Formula 2 (Step S401).

Subsequently, in order to execute time information addition processing by the time information addition processing unit 133 in the MPU 100, the PC 200 transmits the fixed value α thus calculated to the MPU 100 (Step S402). Note that the MPU 100 may temporarily store the fixed value α thus received in the memory 102 as a parameter for the time information addition processing.

Further, the PC 200 initializes a learning data number “j” to “1” (Step S403), and initializes a frame number “i” to “1” (Step S404).

The time information addition processing unit 233 of the PC 200 adds a value indicating time information to a frequency spectrum of a frame 1 (Step S405). Specifically, the time information addition processing unit 233 adds time information as illustrated by a mark A in FIG. 5E according to the first embodiment to the frequency spectrum of the frame 1. Note that this value of the time information A is a value obtained by multiplying the fixed value a calculated at Step S401 by the frame number “i”. The data of the frame 1 (frequency spectrum) to which the time information A is added are stored in the memory 202 of the PC 200 as the data for learning 240b.

Subsequently, the PC 200 determines whether the time information addition processing for all frames in the learning data number 1 is completed or not (Step S406). In a case where it is determined that the time information addition processing for all frames is not completed (“N” at Step S406), the PC 200 increments the frame number “i” to “2” (Step S407), and repeatedly executes the process at Step S405. On the other hand, in a case where it is determined that the time information addition processing for all frames is completed (“Y” at Step S406), the processing flow proceeds to next Step S408.

Subsequently, the PC 200 determines whether the time information addition processing for all learning data is completed or not (Step S408). In a case where it is determined that the time information addition processing for all learning data is not completed (“N” at Step S408), the PC 200 increments the learning data number 1 to “2” (Step S409), and repeatedly executes the processes at Steps S404 to S407. On the other hand, in a case where it is determined that the time information addition processing for all learning data is completed (“Y” at Step S408), the processing flow proceeds to next Step S201.

Note that since the subsequent processes are similar to the processes in the learning flow according to the first embodiment (see FIG. 6), in order to avoid repeated explanation, detailed explanation thereof will be omitted herein. Further, an inference flow according to the present embodiment is similar to the inference flow according to the first embodiment (see FIG. 7), in order to avoid repeated explanation, detailed explanation thereof will be omitted herein.

<Features and Effects of Second Embodiment>

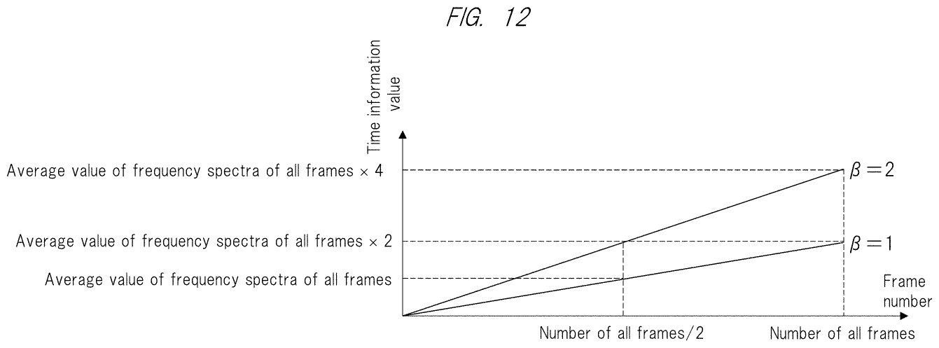

Next, main features and main effects of the time series sensor data processing device 2 according to the second embodiment will be described. FIG. 12 is an explanatory drawing illustrating a relationship between a time information value and the number of all frames.

A feature of the time series sensor data processing device 2 according to the present embodiment is that in order to calculate the value of the time information A to be added, the average value of the frequency spectra of all frames, the number of all frames, and the parameter β for controlling the degree of influence of the time information A are used.

According to the second embodiment, as illustrated in FIG. 12, for example, when the parameter p for controlling the degree of influence of the time information A is “1”, the value of the time information A of the average value of the frequency spectra of all frame is added to a frame at a half position of the number of all frames. Further, if this parameter p is “2”, the value of the time information A that is twice the value at the time of the time information A with “1” is added thereto.

By determining the value of the time information A to be added on the basis of the average value of the frequency spectra of all frames in this manner, it becomes possible to set the value of the time information A, which has appropriate volume with respect to the value of each frequency spectrum. Further, by adjusting the parameter β, it becomes possible to adjust the degree of influence of the time information A on the determination result.

### Third Embodiment

Next, a third embodiment will be described. In the first embodiment, the case where the time information A is added to the data after FFT processing and used has been described. Further, in the second embodiment, the case where the learning of the fixed value α is executed and the degree of influence of the time information A is controlled has been described. In the third embodiment, a case where instead of using data after FFT processing as they are for determining a normality or an abnormality of a multifunction machine, an absolute value of a difference from data after FFT processing of a previous frame is calculated and data obtained by adding time information to data on the difference (difference data) are used for learning and inference will be described. Note that as the difference data, the difference thereof may simply be used instead of the absolute value of the difference.

In the present embodiment, illustration of a time series sensor data processing device will be omitted. For example, in FIG. 2 according to the first embodiment, an FFT processing unit 132 calculates an absolute value of a difference on the basis of data after FFT processing of a previous frame and data after FFT processing of a current frame, and outputs difference data thereof to a time information addition processing unit 133.

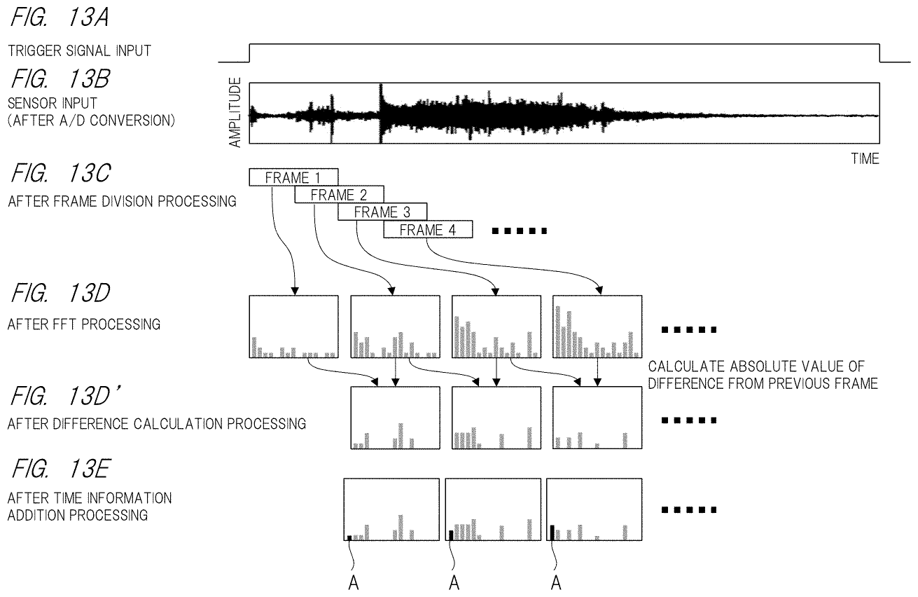

Here, a data image when the absolute value of the difference between the frames is calculated will be described. FIGS. 13A-13E are views illustrating images when an absolute value of a difference between consecutive frames according to a third embodiment is calculated.

Similar to the case illustrated in FIGS. 5A-5E, as illustrated in FIG. 13A, once a trigger signal input becomes active, the trigger signal input maintains an active state for a certain time. Time series sensor data after A/D conversion as illustrated in FIG. 13B are divided into a plurality of frames, and data after FFT processing of each frame are acquired as illustrated in FIG. 13D. Then, an absolute value of a difference between two consecutive frames is calculated, and as illustrated in FIG. 13D′, data after a difference calculating process are generated by the number one less than the number of all frames . Time information A is added to the data after this difference calculation, and as illustrated in FIG. 13E, data after time information addition processing are acquired.

Then, a learning flow and an inference flow are executed. However, they are respectively similar to the processes of the learning flow according to the first embodiment (see FIG. 6) and the processes of the inference flow according to the first embodiment (see FIG. 7). Thus, in order to avoid repeated explanation, detailed explanation thereof will be omitted herein.

For example, in a case where determination of a normality or an abnormality is executed on the basis of an operation sound of a multifunction machine, it is desirable that only the operation sound of the multifunction machine is collected and the determination is executed. However, in fact, various external sounds are collected at the same time, and there is a possibility that this causes deterioration of determination accuracy. Such various external sounds may differ depending upon installation environment of the multifunction machine. Therefore, it is also difficult to cover all situations and learn the operation sound and various external sounds in advance.

According to the present embodiment, even in a case where external sounds are generated relatively constantly and an abnormal sound is generated relatively suddenly, by executing neural network inference processing and result determination processing on the basis of the absolute value of the difference between the two consecutive frames, it becomes possible to detect the abnormal sound of the multifunction machine accurately while removing the external sounds.

### Fourth Embodiment

Next, a fourth embodiment will be described. In the first embodiment, the case where one type of sensor input is used has been described. However, a time series sensor data processing device can also be used for a case where inputs from a plurality of sensors are used. In the fourth embodiment, a case where sensor inputs from a plurality of sensors are used to determine a normality or an abnormality of a multifunction machine will be described.

Further, in the first embodiment, the case where the value obtained by multiplying the fixed value α by the frame number “i” is used as the time information A has been described. In the fourth embodiment, a case where a value acquired from a timer 191 (timer value) of a microprocessor (MPU) 100 is used in place of the frame number “i” and the same time information is added to respective will be described.

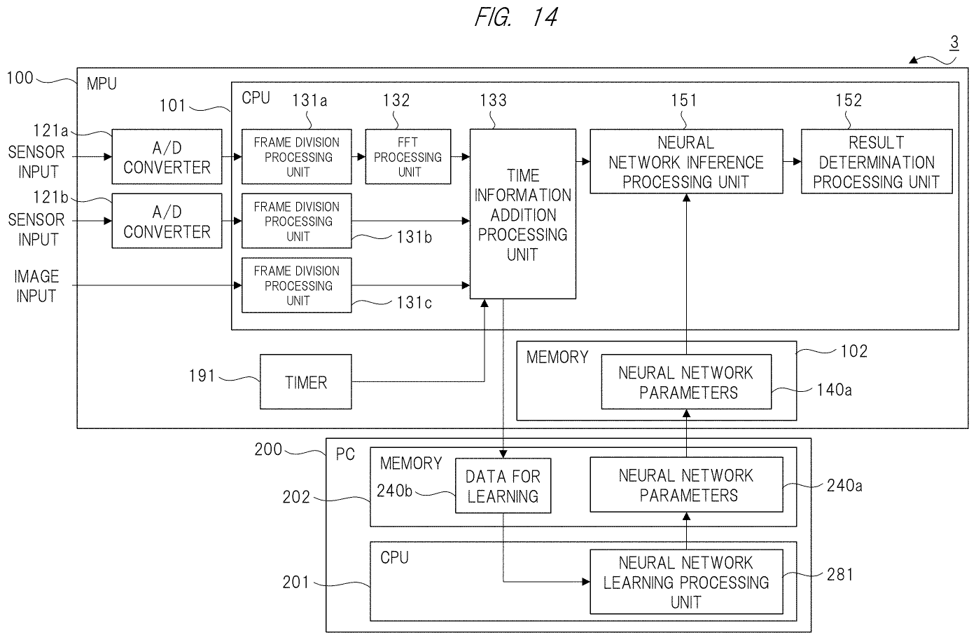

FIG. 14 is a configuration diagram illustrating one example using a semiconductor device according to the fourth embodiment. A time series sensor data processing device 3 according to the present embodiment is different from the time series sensor data processing device 1A according to the first embodiment (see FIG. 2) in that two pieces of sensor data and one piece of image data are inputted therein.

As illustrated in FIG. 14, the time series sensor data processing device 3 includes a microprocessor (MPU) 100 and a personal computer (PC) 200. Since the PC 200 has the similar configuration to that according to the first embodiment, detailed explanation thereof will be omitted.

The MPU 100 includes two A/D converters 121a and 121b, a CPU 101, a memory 102, and a timer 191. The MPU 100 operates in accordance with sensor inputs and/or an image input from the outside. Time series sensor data with analog values are continuously inputted from two different sensors into the A/D converters 121a and 121b. Each of the A/D converters 121a and 121b is configured so as to sequentially sample the inputted analog time series sensor data, and A/D-convert them into digital time series sensor data to output the digital time series sensor data.

The CPU 101 includes three frame division processing units 131a, 131b, and 131c, an FFT processing unit 132, a time information addition processing unit 133, a neural network inference processing unit 151, and a result determination processing unit 152. Two digital time series sensor data outputted from the A/D converters 121a and 121b and image data are respectively inputted to the frame division processing units 131a, 131b, and 131c.

Each of the frame division processing units 131a, 131b, and 131c is configured so as to execute frame division processing in which each of the inputted two time series sensor data and the inputted image input is divided into a plurality of frames and the plurality of frames is generated so that each of the frames has a predetermined frame size.

In the present embodiment, the FFT processing unit 132 is configured so as to execute FFT processing for the frame data of each frame outputted from only the frame division processing unit 131a.

The timer 191 is configured to output a timer value regarding a current time to the time information addition processing unit 133.

The time information addition processing unit 133 is configured so as to execute time information addition processing in which the timer value inputted from the timer 191 is added to a frequency spectrum of each frame outputted from the FFT processing unit 132, each frame data outputted from the frame division processing unit 131b, and each frame image data outputted from the frame division processing unit 131c. In this case, the same timer value is added to the frame data that are outputted from each of the frame division processing units 131a, 131b, and 131c at the same timing.

The other components illustrated in FIG. 14 are substantially similar to the components illustrated in FIG. 2 according to the first embodiment. For that reason, detailed explanation thereof will be omitted herein.

According to the present embodiment, by configuring the time series sensor data processing device 3 in this manner, in the system capable of comprehensively determining the information acquired from the plurality of sensors, it becomes possible to determine a normality or an abnormality of the multifunction machine in consideration of timing. Further, since the same timer value (time information) generated from one timer is added to each of the sensor data, it becomes possible to process the sensor data of the same timing so as to be synchronized with each other in the subsequent processes.

Note that FIG. 14 illustrates, as an example, the case where there are two types of sensor inputs and one type of image input. However, the time series sensor data processing device 3 according to the present embodiment is not limited to this configuration, and any number of sensor inputs and any number of image inputs may be used. Further, FIG. 14 illustrates the configuration in which the two sensor inputs are respectively inputted to the A/D converters 121a and 121b. However, it may be configured so that the A/D converters 121a and 121b are not provided in a case where a sensor configured to output a digital value as sensor data is used. Further, the time series sensor data processing device 3 may be configured so as to include a simple counter in place of the timer 191, or may be configured so as to deal with a real time in combination with an RTC (Real Time Clock) or the like. Moreover, in FIG. 14, the frame division processing units 131a, 131b, and 131c, the FFT processing unit 132, and the time information addition processing unit 133 of the MPU 100 are configured so as to respectively execute the frame division processing, the FFT processing, and the time information addition processing as software processing. However, the respective units may be configured by dedicated hardware in order to add more strict time information.

As described above, the invention made by inventors of the present application has been described specifically on the basis of the embodiments. However, the present invention is not limited to the first to fourth embodiments described above, and it goes without saying that the present invention may be modified into various forms without departing from the substance thereof.

For example, in each of the second to fourth embodiments, the configuration and the operation has been described using the time series sensor data processing device 1A according to the first embodiment illustrated in FIG. 2. However, the similar configuration may be adopted in the time series sensor data processing device 1B illustrated in FIG. 3, and the similar operation may be executed. Further, the features of each of the first to fourth embodiments may be combined appropriately.

What is claimed is:

1. A time series sensor data processing device, comprising:
a frame generating unit configured to generate a plurality of frames from time series sensor data acquired from a sensor, each of the frames having a predetermined frame size, the sensor being provided in an apparatus;
a time information adding unit configured to add a value indicating corresponding time information to each of the generated frames; and
a determining unit configured to determine presence or absence of an abnormality of the apparatus by using a neural network, the neural network learning a combination of each of the plurality of frames and the value indicating the corresponding time information and a combination of a data pattern of each frame stored in advance and predetermined timing.

2. The time series sensor data processing device according to claim 1, further comprising:
a memory configured to store the plurality of frames to each of which the value indicating the corresponding time information is added as data for learning;
a learning unit configured to execute a learning process by the neural network on a basis of the data for learning stored in the memory; and
a correcting unit configured to correct the combination of the data pattern of the frame and the predetermined timing on a basis of a result of the learning process executed by the learning unit.

3. The time series sensor data processing device according to claim 1, further comprising:
an FFT processing unit configured to perform FFT processing for each of the plurality of frames,
wherein the time information adding unit is configured to add the value indicating the corresponding time information to a frequency spectrum of each of the plurality of frames acquired by performing the FFT processing.

4. The time series sensor data processing device according to claim 1,
wherein the frame generating unit is configured to assign frame numbers to the generated plurality of frames in order, and
wherein the time information adding unit is configured to calculate a value of the time information of the corresponding frame by multiplying the frame number by a fixed value.

5. The time series sensor data processing device according to claim 4,
wherein the fixed value is calculated using values calculated from the frequency spectra of all of the plurality of frames.

6. The time series sensor data processing device according to claim 4, further comprising:
a timer configured to measure a time,
wherein the time information adding unit is configured to add time information acquired from the timer to each of the generated plurality of frames as the value indicating the corresponding time information.

7. The time series sensor data processing device according to claim 3,
wherein the FFT processing unit is configured to calculate a difference or an absolute value thereof between frame data after FFT processing for a current frame and frame data after FFT processing for a previous frame one before the current frame, and
wherein the determining unit is configured to determine the presence or absence of the abnormality of the apparatus on a basis of the difference or the absolute value thereof.

8. The time series sensor data processing device according to claim 1,
wherein a plurality of sensors is provided in the apparatus,
wherein the frame generating unit is configured to generate a plurality of frames, each of which has a predetermined frame size, from time series sensor data acquired from each of the plurality of sensors, and
wherein the time information adding unit is configured to add a value indicating same time information to each of the frames generated for the plurality of sensors at same timing.

9. A time series sensor data processing method, comprising:
generating a plurality of frames from time series sensor data acquired from a sensor, each of the frames having a predetermined frame size, the sensor being provided in an apparatus;
adding a value indicating corresponding time information to each of the generated frames; and
determining presence or absence of an abnormality of the apparatus by using a neural network, the neural network learning a combination of each of the plurality of frames and the value indicating the corresponding time information and a combination of a data pattern of each frame stored in advance and predetermined timing.

10. The time series sensor data processing method according to claim 9, further comprising:
storing, in a memory, the plurality of frames to each of which the value indicating the corresponding time information is added as data for learning;
executing a learning process by the neural network on a basis of the data for learning stored in the memory; and
correcting the combination of the data pattern of the frame and the predetermined timing on a basis of a result of the learning process.
